(19) United States
(12) Patent Application Publication
(10) Pub. No.: US 2026/0270038 A1
(43) Pub. Date: Sep. 10, 2026

(54) METHOD AND APPARATUS FOR SUB-BAND FULL DUPLEX CONFIGURATIONS IN MOBILE COMMUNICATIONS

(71) Applicant: MediaTek Singapore Pte. Ltd., Singapore (SG)

(72) Inventors: Sumaila Anning MAHAMA, Cambridge (GB); Mohammed S Aleabe AL-IMARI, Cambridge (GB)

(21) Appl. No.: 19/165,665

(22) PCT Filed: May 8, 2024
(86) PCT No.: PCT/CN2024/091557

§ 371 Date: Sep. 16, 2025

Related U.S. Application Data
(60) Provisional application No. 63/500,929, filed on May 9, 2023.

(51) Int. Cl. H04L 5/14; H04L 5/00

(52) U.S. Cl. CPC H04L 5/1438; H04L 5/0044

(57) ABSTRACT

Various solutions for sub-band full duplex (SBFD) configurations with respect to an apparatus in mobile communications are described. The apparatus may transmit at least two SBFD configurations to a user equipment (UE). The at least two SBFD configurations includes a first SBFD configuration and a second SBFD configuration. The apparatus may transceive data with the UE within a first set of slots according to the first SBFD configuration. The apparatus may transceive data with the UE within a second set of slots according to the second SBFD configuration.

### CROSS REFERENCE TO RELATED PATENT APPLICATION(S)

The present disclosure is part of a non-provisional application claiming the priority benefit of U.S. Patent Application No. 63/500,929, filed 9 May 2023, the content of which herein being incorporated by reference in its entirety.

### TECHNICAL FIELD

The present disclosure is generally related to mobile communications and, more particularly, to sub-band full duplex (SBFD) configurations with respect to apparatus in mobile communications.

### BACKGROUND

Unless otherwise indicated herein, approaches described in this section are not prior art to the claims listed below and are not admitted as prior art by inclusion in this section.

In 5^{th}-generation (5G) New Radio (NR) mobile communications, sub-band full duplex (SBFD) technology is introduced. Generally, a single SBFD configuration is applied between the network node (e.g., base station) and the user equipment (UE.) However, under the situation of applying single SBFD configuration, there may be significant interference from a neighbor network node/UE when a transmission direction of a sub-band associated with the SBFD configuration is opposite to a transmission direction of a band associated with a slot utilized by the neighbor network node/UE.

Accordingly, how to reduce the interferences from neighbor network node/UE becomes an important issue in the newly developed wireless communication network. Therefore, there is a need to provide proper schemes to avoid and reduce interferences for SBFD communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to sub-band full duplex (SBFD) configurations with respect to apparatus in mobile communications.

In one aspect, a method may involve an apparatus transmitting at least two SBFD configurations to a user equipment (UE). The at least two SBFD configurations includes a first SBFD configuration and a second SBFD configuration. The method may also involve the apparatus transceiving data with the UE within a first set of slots according to the first SBFD configuration. The method may further involve the apparatus transceiving data with the UE within a second set of slots according to the second SBFD configuration.

In one aspect, a method may involve an apparatus receiving at least two SBFD configurations from a network node. The at least two SBFD configurations includes a first SBFD configuration and a second SBFD configuration. The method may also involve the apparatus applying the at least two SBFD configurations. The method may further involve the apparatus transceiving data with the network node within a first set of slots according to the first SBFD configuration. The method may further involve the apparatus transceiving data with the network node within a second set of slots according to the second SBFD configuration.

In one aspect, an apparatus may comprise a transceiver which, during operation, wirelessly communicates with at least one UE of a wireless network. The apparatus may also comprise a processor communicatively coupled to the transceiver. The processor, during operation, may perform operations comprising transmitting, via the transceiver, at least two SBFD configurations to the UE. The at least two SBFD configurations includes a first SBFD configuration and a second SBFD configuration. The processor may also perform operations comprising transceiving, via the transceiver, data with the UE within a first set of slots according to the first SBFD configuration. The processor may further perform operations comprising transceiving, via the transceiver, data with the UE within a second set of slots according to the second SBFD configuration.

In one aspect, an apparatus may comprise a transceiver which, during operation, wirelessly communicates with at least one network node of a wireless network. The apparatus may also comprise a processor communicatively coupled to the transceiver. The processor, during operation, may perform operations comprising receiving, via the transceiver, at least two SBFD configurations from the network node. The at least two SBFD configurations includes a first SBFD configuration and a second SBFD configuration. The processor may also perform operations comprising applying the at least two SBFD configurations. The processor may further perform operations comprising transceiving, via the transceiver, data with the network node within a first set of slots according to the first SBFD configuration. The processor may further perform operations comprising transceiving, via the transceiver, data with the network node within a second set of slots according to the second SBFD configuration.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a diagram depicting an example scenario under schemes in accordance with implementations of the present disclosure.

FIG. 4 is a diagram depicting an example scenario under schemes in accordance with implementations of the present disclosure.

FIG. 5 is a diagram depicting an example scenario under schemes in accordance with implementations of the present disclosure.

FIG. 6 is a diagram depicting an example scenario under schemes in accordance with implementations of the present disclosure.

FIG. 7 is a block diagram of an example communication system in accordance with an implementation of the present disclosure.

FIG. 8 is a flowchart of an example process in accordance with an implementation of the present disclosure.

FIG. 9 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sub-band full duplex (SBFD) configurations with respect to apparatus in mobile communications. According to the present disclosure, a number of possible solutions may be implemented separately or jointly. That is, although these possible solutions may be described below separately, two or more of these possible solutions may be implemented in one combination or another.

Regarding to the present disclosure, multiple SBFD configurations may be applied. In particular, at least two SBFD configurations may be simultaneously applied between a network node (e.g., base station) and a user equipment (UE). Different SBFD configurations may be associated with different sets of slots. Applying different SBFD configurations associated with different sets of slots may enhance the flexibility of preventing the interferences from different neighbor network node(s) and/or UE(s).

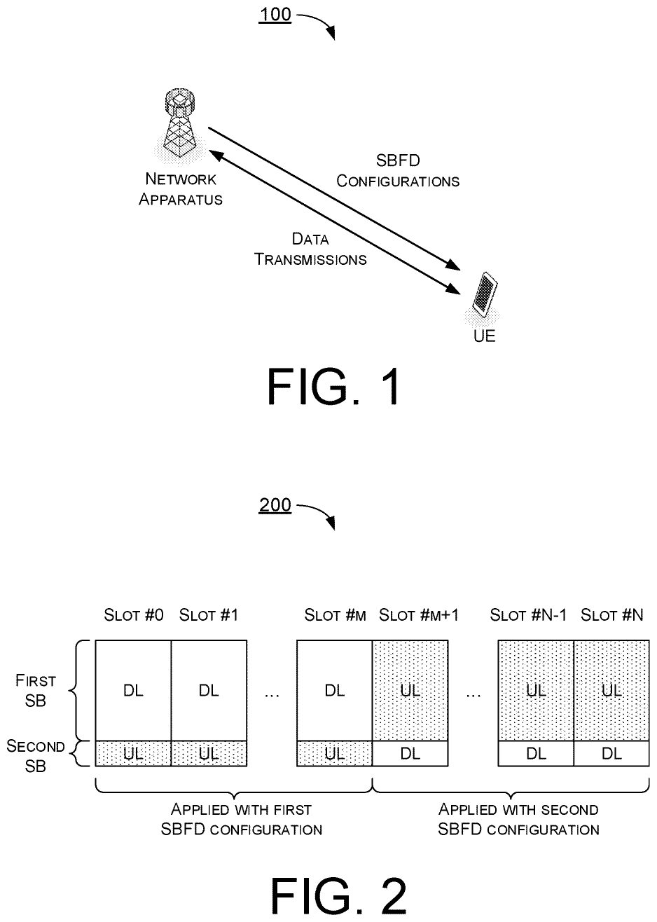

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the current network framework. The UE may connect to the network side. The network side may comprise one or more than one network nodes.

In some embodiments, the network node may transmit at least two SBFD configurations to the UE. The at least two SBFD configurations may include a first SBFD configuration associated with a first set of slots and a second SBFD configuration associated with a second set of slots. After receiving, the UE may simultaneously apply the at least two SBFD configurations. Afterwards, the network node may: (1) transmit data (i.e., downlink transmission) to the UE or receive data (i.e., uplink transmission) from the UE within the first set of slots according to the first SBFD configuration; and (2) transmit data (i.e., downlink transmission) to the UE or receive data (i.e., uplink transmission) from the UE within the second set of slots according to a second SBFD configurations.

In some implementations, the at least two SBFD configurations may be included in a layer-1 signaling (e.g., physical layer signaling). In other words, the at least two SBFD configurations may be transmitted via the layer-1 signaling. The layer-1 signaling may comprise, for example, a downlink control information (DCI).

In some implementations, the at least two SBFD configurations may be included in a higher layer signaling. In other words, the at least two SBFD configurations may be transmitted via the higher layer signaling. The higher layer signaling may comprise, for example, a radio resource control (RRC) signaling or a medium access control (MAC) control element (CE).

In some implementations, an indication of where each SBFD configuration is applied may be provided from the network node to the UE. In particular, the network node may transmit the indicator to the UE. The indicator may indicate to the UE that the first SBFD configuration is applied to the first set of slots and the second SBFD configuration is applied to the second set of slots. In some cases, the second set of slots may not overlap the first set of slots.

In some implementations, the indicator may be included in a layer-1 signaling (e.g., physical layer signaling.) In other words, the indicator may be transmitted via the layer-1 signaling. The layer-1 signaling may comprise, for example, a DCI.

In some implementations, the indicator may be included in a higher layer signaling. In other words, the indicator may be transmitted via the higher layer signaling. The higher layer signaling may comprise, for example, an RRC signaling or a MAC CE.

FIG. 2 illustrates an example scenario 200 under schemes in accordance with implementations of the present disclosure. In particular, a first SBFD configuration of the at least two SBFD configurations is associated with a first set of slots including slots #0 to #M. A second SBFD configuration of the at least two SBFD configurations is associated with a second set of slots including slots #M+1 to #N.

According to the first SBFD configuration, each slot of the first set of slots is allocated as a first sub-band (SB) and a second SB while the first SB is for downlink (DL) transmission and the second SB is for uplink (UL) transmission. According to the second SBFD configuration, each slot of the second set of slots is allocated as the first SB and the second SB while the first SB is for UL transmission and the second SB is for DL transmission.

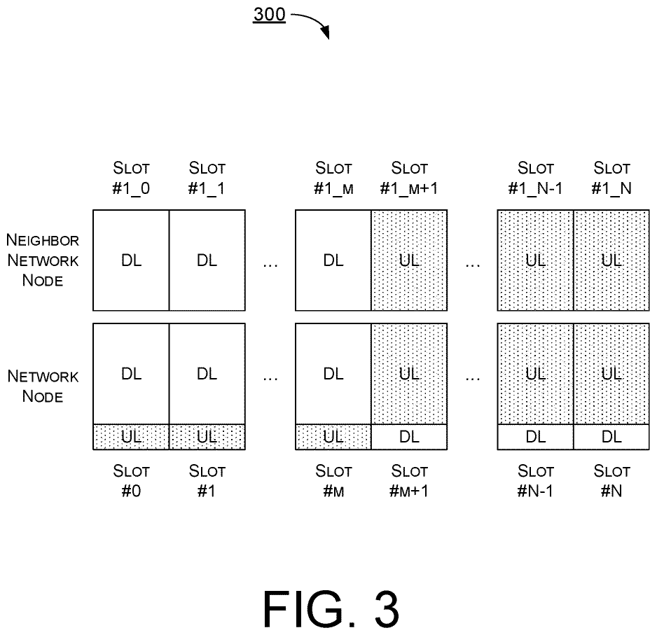

FIG. 3 illustrates an example scenario 300 under schemes in accordance with implementations of the present disclosure. In particular, the network may determine the at least two SBFD configurations based on a slot information received from a neighbor network node. In particular, the slot information received from the neighbor network may indicate to the network node that the neighbor network node may utilize: (1) slots #1_0 to #1_M for DL transmission; and (2) slots #1_M+1 to #1_N for UL transmission. In other words, after receiving the slot information from the neighbor network node, the network node may be aware of that slots #1_0 to #1_M utilized by the neighbor network node are for DL transmission and slots #1_M+1 to #1_N utilized by the neighbor network node are for UL transmission.

Then, when the network node needs to utilize the first set of slots including slots #0 to #M, which have the first SB adjacent to the band of the slots #1_0 to #1_M, to exchange data with the UE (e.g., transmit data to the UE) under SBFD scheme, the network node may determine the first SBFD configuration associated with slots #0 to #M for indicating to the UE that each slot of the first set of slots is allocated as the first SB for DL transmission and the second SB for UL transmission.

Similarly, when the network node needs to utilize the second set of slots including slots #M+1 to #N, which have the first SB adjacent to the band of slots #1_M+1 to #1_N, to exchange data with the UE (e.g., receive data from the UE) under SBFD scheme, the network node may determine the second SBFD configuration associated with slots #M+1 to #N for indicating to the UE that each slot of the second set of slots is allocated as the first SB for UL transmission and the second SB for DL transmission.

Therefore, in these cases, because the first SB of the first set of slots #0 to #M utilized by the network node and the adjacent band of slots #1_0 to #1_M utilized by the neighbor node are all for the same type of transmissions (i.e., DL transmissions,) the interference from the neighbor network node/UE during the slots #0 to #M may be significantly reduced. Further, because the first SB of the first set of slots #M+1 to #N utilized by the network node and the adjacent band of slots #1_M+1 to #1_N utilized by the neighbor node are all for the same type of transmissions (i.e., UL transmissions,) the interference from the neighbor network node/UE during the slots #M+1 to #N may be significantly reduced as well. Accordingly, simultaneously applying the first SBFD configuration to the first set of slots and applying the second SBFD configuration to the second set of slots may enhance the flexibility of preventing the interferences from neighbor network node/UE.

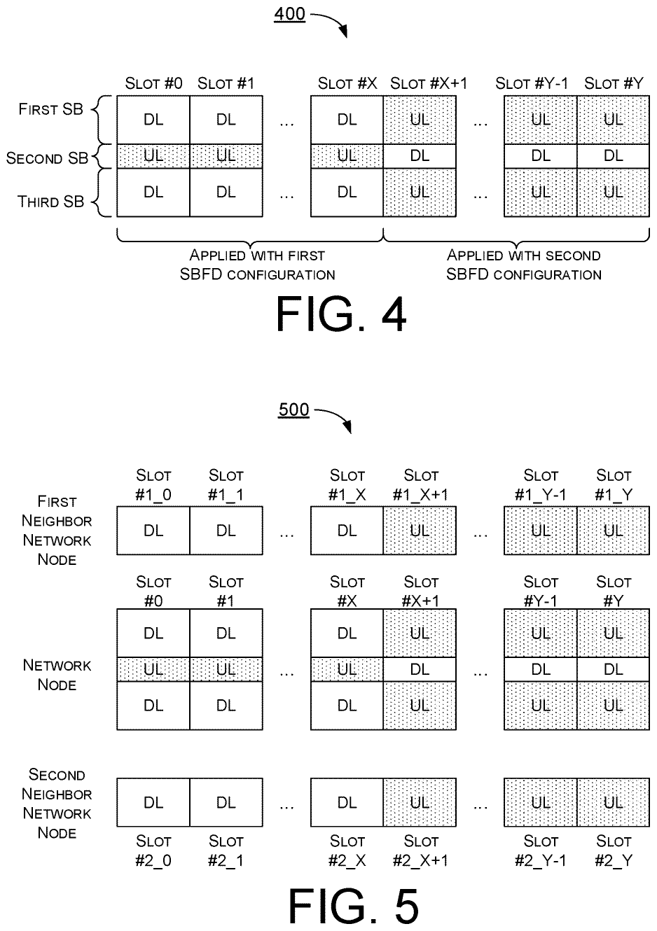

FIG. 4 illustrates an example scenario 400 under schemes in accordance with implementations of the present disclosure. In particular, a first SBFD configuration of the at least two SBFD configurations is associated with a first set of slots including slots #0 to #X. A second SBFD configuration of the at least two SBFD configurations is associated with a second set of slots including slots #X+1 to #Y.

According to the first SBFD configuration, each slot of the first set of slots is allocated as a first SB, a second SB and a third SB while the first SB and the third SB are for DL transmission, and the second SB is for UL transmission. According to the second SBFD configuration, each slot of the second set of slots is allocated as the first SB, the second SB and the third SB while the first SB and the third SB are for UL transmission and the second SB is for DL transmission.

FIG. 5 illustrates an example scenario 500 under schemes in accordance with implementations of the present disclosure. In particular, the network may determine the at least two SBFD configurations based on a first slot information received from a first neighbor network node and a second slot information received from a second neighbor network node.

In particular, the first slot information received from the first neighbor network may indicate to the network node that the first neighbor network node may utilize: (1) slots #1_0 to #1_X for DL transmission; and (2) slots #1_X+1 to #1_Y for UL transmission. In other words, after receiving the first slot information from the first neighbor network node, the network node may be aware of that slots #1_0 to #1_X utilized by the first neighbor network node are for DL transmission and slots #1_X+1 to #1_Y utilized by the first neighbor network node are for UL transmission.

Further, the second slot information received from the second neighbor network may indicate to the network node that the second neighbor network node may utilize: (1) slots #2_0 to #2_X for DL transmission; and (2) slots #2_X+1 to #2_Y for UL transmission. In other words, after receiving the second slot information from the second neighbor network node, the network node may be aware of that slots #2_0 to #2_X utilized by the second neighbor network node are for DL transmission and slots #2_X+1 to #2_Y utilized by the second neighbor network node are for UL transmission.

Then, when the network node needs to utilize the first set of slots including slots #0 to #X, which have the first SB adjacent to the band of slots #1_0 to #1_X and the third SB adjacent to the band of slots #2_0 to #2_X, to exchange data with the UE (e.g., transmit data to the UE) under SBFD scheme, the network node may determine the first SBFD configuration associated with slots #0 to #X for indicating to the UE that each slot of the first set of slots is allocated as the first SB for DL transmission, the second SB for UL transmission and the third SB for DL transmission.

Similarly, when the network node needs to utilize the second set of slots including slots #X+1 to #Y, which have the first SB adjacent to the band of slots #1_X+1 to #1_Y and the third SB adjacent to the slot #2_X+1 to #2_Y, to exchange data with the UE e.g., receive data from the UE) under SBFD scheme, the network node may determine the second SBFD configuration associated with slots #X+1 to #Y for indicating to the UE that each slot of the second set of slots is allocated as the first SB for UL transmission, the second SB for DL transmission and the third SB for UL transmission.

Therefore, in these cases, because the first SB of the first set of slots #0 to #X utilized by the network node and the adjacent band of slots #1_0 to #1_X utilized by the first neighbor node are all for the same type of transmissions (i.e., DL transmissions,) the interference from the first neighbor network node/UE during the slots #o to #X may be significantly reduced. Further, because the first SB of the first set of slots #X+1 to #Y utilized by the network node and the adjacent band of slots #1_X+1 to #1_Y utilized by the first neighbor node are all for the same type of transmissions (i.e., UL transmissions,) the interference from the first neighbor network node/UE during the slots #X+1 to #Y may be significantly reduced as well.

In addition, because the third SB of the first set of slots #0 to #X utilized by the network node and the adjacent band of slots #2_0 to #2_X utilized by the second neighbor node are all for the same type of transmissions (i.e., DL transmissions,) the interference from the second neighbor network node/UE during the slots #0 to #X may be significantly reduced. Further, because the third SB of the first set of slots #X+1 to #Y utilized by the network node and the adjacent band of slots #2_X+1 to #2_Y utilized by the second neighbor node are all for the same type of transmissions (i.e., UL transmissions,) the interference from the second neighbor network node/UE during the slots #X+1 to #Y may be significantly reduced as well.

Accordingly, simultaneously applying the first SBFD configuration to the first set of slots and applying the second SBFD configuration to the second set of slots may enhance the flexibility of preventing the interferences from neighbor network nodes/UEs.

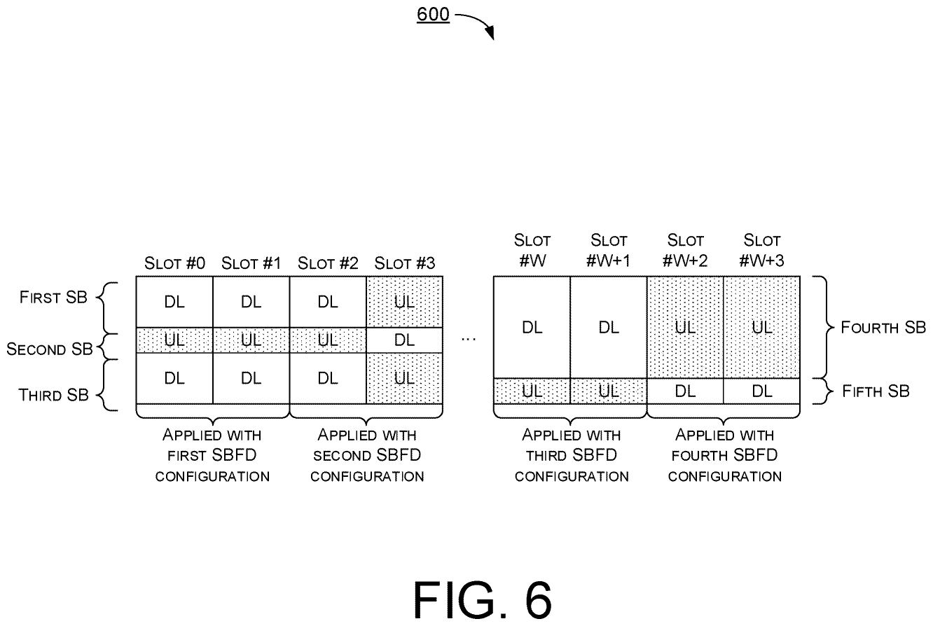

FIG. 6 illustrates an example scenario 600 under schemes in accordance with implementations of the present disclosure. In some implementations, more than two SBFD configurations may be simultaneously applied between the network node and the UE. In particular, a first SBFD configuration of the SBFD configurations is associated with a first set of slots including slots #0 and #1. A second SBFD configuration of the at least two SBFD configurations is associated with a second set of slots including slots #2 and #3. A third SBFD configuration of the at least two SBFD configurations is associated with a third set of slots including slots #W and #W+1. A fourth SBFD configuration of the at least two SBFD configurations is associated with a fourth set of slots including slots #W+2 and #W+3.

According to the first SBFD configuration, each slot of the first set of slots is allocated as a first SB, a second SB and a third SB while the first SB and the third SB are for DL transmission, and the second SB is for UL transmission. According to the second SBFD configuration, each slot of the second set of slots is allocated as the first SB, the second SB and the third SB while the first SB and the third SB are for UL transmission and the second SB is for DL transmission.

According to the third SBFD configuration, each slot of the third set of slots is allocated as a fourth SB and a fifth SB while the fourth SB is for DL transmission, and the fifth SB is for UL transmission. According to the fourth SBFD configuration, each slot of the third set of slots is allocated as the fourth SB and the fifth SB while the fourth SB is for UL transmission, and the fifth SB is for DL transmission.

Simultaneously applying the first SBFD configuration to the first set of slots, applying the second SBFD configuration to the second set of slots, applying the third SBFD configuration to the third set of slots and applying the fourth SBFD configuration to the fourth set of slots may enhance the flexibility of preventing the interferences from neighbor network nodes/UEs.

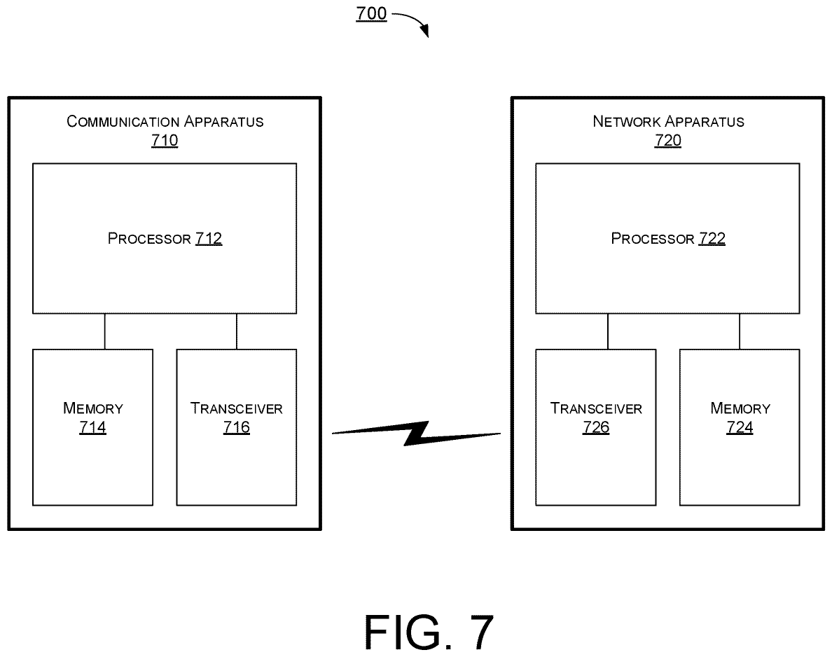

Illustrative Implementations FIG. 7 illustrates an example communication system 700 having an example communication apparatus 710 and an example network apparatus 720 in accordance with an implementation of the present disclosure. Each of communication apparatus 710 and network apparatus 720 may perform various functions to implement schemes, techniques, processes and methods described herein pertaining to SFBD configurations with respect to user equipment and network apparatus in mobile communications, including scenarios/schemes described above as well as process 800 and 900 described below.

Communication apparatus 710 may be a part of an electronic apparatus, which may be a UE such as a portable or mobile apparatus, a wearable apparatus, a wireless communication apparatus or a computing apparatus. For instance, communication apparatus 710 may be implemented in a smartphone, a smartwatch, a personal digital assistant, a digital camera, or a computing equipment such as a tablet computer, a laptop computer or a notebook computer. Communication apparatus 710 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 710 may be implemented in a smart thermostat, a smart fridge, a smart door lock, a wireless speaker or a home control center. Alternatively, communication apparatus 710 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 710 may include at least some of those components shown in FIG. 7 such as a processor 712, for example. Communication apparatus 710 may further include one or more other components not pertinent to the proposed scheme of the present disclosure (e.g., internal power supply, display device and/or user interface device), and, thus, such component(s) of communication apparatus 710 are neither shown in FIG. 7 nor described below in the interest of simplicity and brevity.

Network apparatus 720 may be a part of a network apparatus, which may be a network node such as a satellite, a base station, a small cell, a router or a gateway. For instance, network apparatus 720 may be implemented in an eNodeB in an LTE network, in a gNB in a 5G/NR, IoT, NB-IoT or IIoT network or in a satellite or base station in a 6G network. Alternatively, network apparatus 720 may be implemented in the form of one or more IC chips such as, for example and without limitation, one or more single-core processors, one or more multi-core processors, or one or more RISC or CISC processors. Network apparatus 720 may include at least some of those components shown in FIG. 7 such as a processor 722, for example. Network apparatus 720 may further include one or more other components not pertinent to the proposed scheme of the present disclosure (e.g., internal power supply, display device and/or user interface device), and, thus, such component(s) of network apparatus 720 are neither shown in FIG. 7 nor described below in the interest of simplicity and brevity.

In one aspect, each of processor 712 and processor 722 may be implemented in the form of one or more single-core processors, one or more multi-core processors, or one or more CISC processors. That is, even though a singular term “a processor” is used herein to refer to processor 712 and processor 722, each of processor 712 and processor 722 may include multiple processors in some implementations and a single processor in other implementations in accordance with the present disclosure. In another aspect, each of processor 712 and processor 722 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 712 and processor 722 is a special-purpose machine specifically designed, arranged and configured to perform specific tasks including autonomous reliability enhancements in a device (e.g., as represented by communication apparatus 710) and a network (e.g., as represented by network apparatus 720) in accordance with various implementations of the present disclosure.

In some implementations, communication apparatus 710 may also include a transceiver 716 coupled to processor 712 and capable of wirelessly transmitting and receiving data. In some implementations, communication apparatus 710 may further include a memory 714 coupled to processor 712 and capable of being accessed by processor 712 and storing data therein. In some implementations, network apparatus 720 may also include a transceiver 726 coupled to processor 722 and capable of wirelessly transmitting and receiving data. In some implementations, network apparatus 720 may further include a memory 724 coupled to processor 722 and capable of being accessed by processor 722 and storing data therein. Accordingly, communication apparatus 710 and network apparatus 720 may wirelessly communicate with each other via transceiver 716 and transceiver 726, respectively. To aid better understanding, the following description of the operations, functionalities and capabilities of each of communication apparatus 710 and network apparatus 720 is provided in the context of a mobile communication environment in which communication apparatus 710 is implemented in or as a communication apparatus or a UE and network apparatus 720 is implemented in or as a network node of a communication network.

In some implementations, processor 722 may transmit, by the transceiver 726, at least two SBFD configurations to a UE. The at least two SBFD configurations includes a first SBFD configuration and a second SBFD configuration. Processor 722 may transceive, by the transceiver 726, data with the UE within a first set of slots according to the first SBFD configuration. Processor 722 may transceive, by the transceiver 726, data with the UE within a second set of slots according to the second SBFD configuration.

In some implementations, the at least two SBFD configurations are included in a higher layer signaling.

In some implementations, the at least two SBFD configurations are included in a In some implementations, processor 722 may transmit, by the transceiver 726, an indicator to the UE. The indicator indicates to the UE that the first SBFD configuration is applied to the first set of slots and the second SBFD configuration is applied to the second set of slots.

In some implementations, the second set of slots does not overlap the first set of slots.

In some implementations, the indicator is included in a higher layer signaling.

In some implementations, the indicator is included in a layer-1 signaling.

In some implementations, processor 722 may determine the at least two SBFD configurations based on a slot information received from a network node.

In some implementations, a downlink band associated with the first SBFD configuration is adjacent to a downlink band associated with the slot information.

In some implementations, an uplink band associated with the second SBFD configuration is adjacent to an uplink band associated with the slot information.

In some implementations, processor 712 may receive, by the transceiver 716, at least two SBFD configurations from a network node. The at least two SBFD configurations includes a first SBFD configuration and a second SBFD configuration. Processor 712 may apply the at least two SBFD configurations. Processor 712 may transceive, by the transceiver 716, data with the network node within a first set of slots according to the first SBFD configuration. Processor 712 may transceive, by the transceiver 716, data with the network node within a second set of slots according to the second SBFD configuration.

In some implementations, the at least two SBFD configurations are included in a higher layer signaling.

In some implementations, the at least two SBFD configurations are included in a layer-1 signaling.

In some implementations, processor 712 may receive, by the transceiver 716, an indicator from the network node. The indicator indicates to the apparatus that the first SBFD configuration is applied to the first set of slots and the second SBFD configuration is applied to the second set of slots.

In some implementations, the second set of slots does not overlap the first set of slots.

In some implementations, the indicator is included in a higher layer signaling.

In some implementations, the indicator is included a layer-1 signaling In some implementations, a downlink band associated with the first SBFD configuration is adjacent to a downlink band associated with a slot information of another network node.

In some implementations, an uplink band associated with the second SBFD configuration is adjacent to an uplink band associated with a slot information of another network node.

### Illustrative Processes

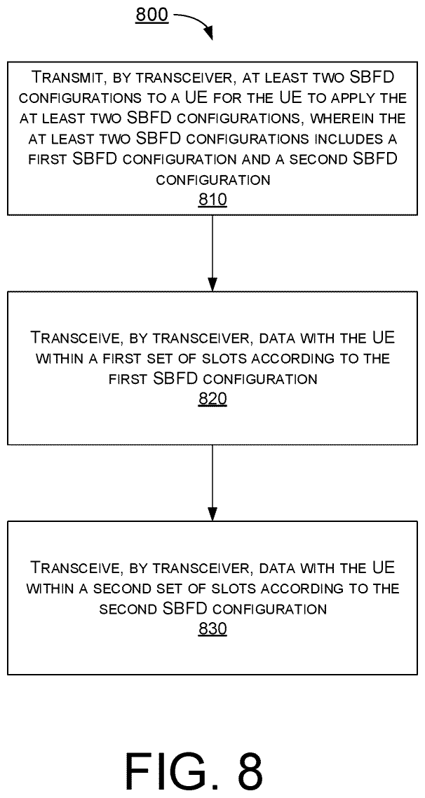

FIG. 8 illustrates an example process 800 in accordance with an implementation of the present disclosure. Process 800 may be an example implementation of above scenarios/schemes, whether partially or completely, with respect to SBFD configurations of the present disclosure. Process 800 may represent an aspect of implementation of features of network apparatus 720. Process 800 may include one or more operations, actions, or functions as illustrated by one or more of blocks 810 to 830. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may be implemented by network apparatus 720 or any suitable network device or machine type devices. Solely for illustrative purposes and without limitation, process 800 is described below in the context of network apparatus 720. Process 800 may begin at block 810.

At 810, process 800 may involve processor 722 of network apparatus 720 transmitting at least two SBFD configurations to a UE. The at least two SBFD configurations includes a first SBFD configuration and a second SBFD configuration. Process 800 may proceed from 810 to 820.

At 820, process 800 may involve processor 722 transceiving data with the UE within a first set of slots according to the first SBFD configuration. Process 800 may proceed from 820 to 830.

At 830, process 800 may involve processor 722 transceiving data with the UE within a second set of slots according to the second SBFD configuration.

In some implementation, process 800 may involve processor 722 transmitting an indicator to the UE. The indicator may indicate that the first SBFD configuration is applied to the first set of slots and the second SBFD configuration is applied to the second set of slots.

In some implementation, process 800 may involve processor 722 determining the at least two SBFD configurations based on a slot information received from a network node.

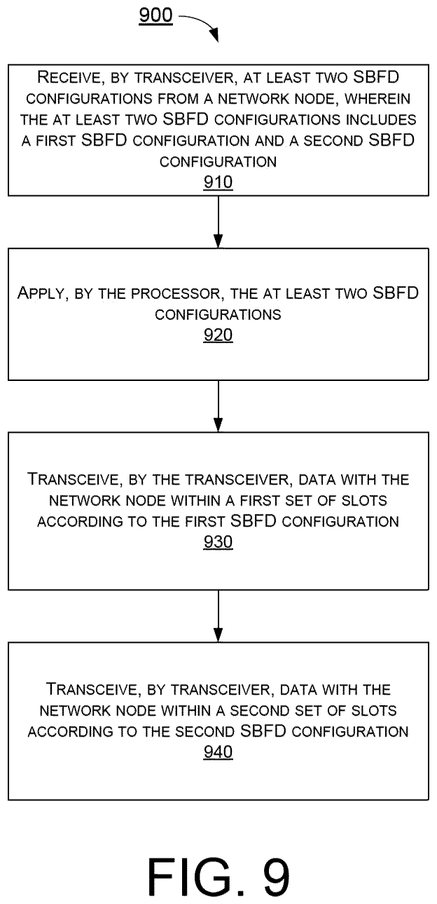

FIG. 9 illustrates an example process 900 in accordance with an implementation of the present disclosure. Process 900 may be an example implementation of above scenarios/schemes, whether partially or completely, with respect to SBFD configurations of the present disclosure. Process 900 may represent an aspect of implementation of features of communication apparatus 710. Process 900 may include one or more operations, actions, or functions as illustrated by one or more of blocks 910 to 940. Although illustrated as discrete blocks, various blocks of process 900 may be divided into additional blocks, combined into fewer blocks, or eliminated, depending on the desired implementation. Moreover, the blocks of process 900 may be executed in the order shown in FIG. 9 or, alternatively, in a different order. Process 900 may be implemented by communication apparatus 710 or any suitable UE or machine type devices. Solely for illustrative purposes and without limitation, process 900 is described below in the context of communication apparatus 710. Process 900 may begin at block 910.

At 910, process 900 may involve processor 712 of communication apparatus 710 receiving at least two SBFD configurations from a network node. The at least two SBFD configurations includes a first SBFD configuration and a second SBFD configuration. Process 900 may proceed from 910 to 920.

At 920, process 900 may involve processor 712 applying the at least two SBFD configurations. Process 900 may proceed from 920 to 930.

At 930, process 900 may involve processor 712 of communication apparatus 710 transceiving data with the network node within a first set of slots according to the first SBFD configuration. Process 900 may proceed from 930 to 940.

At 940, process 900 may involve processor 712 of communication apparatus 710 transceiving data with the network node within a second set of slots according to the second SBFD configuration.

In some implementations, process 900 may involve processor 712 receiving an indicator from the network node. The indicator may indicate that the first SBFD configuration is applied to the first set of slots and the second SBFD configuration is applied to the second set of slots.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of an apparatus, at least two sub-band full duplex (SBFD) configurations to a user equipment (UE), wherein the at least two SBFD configurations comprises a first SBFD configuration and a second SBFD configuration;
transceiving, by the processor, data with the UE within a first set of slots according to the first SBFD configuration; and
transceiving, by the processor, data with the UE within a second set of slots according to the second SBFD configuration.

2. The method of claim 1, wherein the at least two SBFD configurations are included in a higher layer signaling.

3. The method of claim 1, wherein the at least two SBFD configurations are included in a layer-1 signaling.

4. The method of claim 1, further comprising:
transmitting, by the processor, an indicator to the UE, wherein the indicator indicates that the first SBFD configuration is applied to the first set of slots and the second SBFD configuration is applied to the second set of slots.

5. The method of claim 4, wherein the second set of slots does not overlap the first set of slots.

6. The method of claim 4, wherein the indicator is included in a higher layer signaling.

7. The method of claim 4, wherein the indicator is included in a layer-1 signaling.

8. The method of claim 1, further comprising:
determining, by the processor, the at least two SBFD configurations based on a slot information received from a network node.

9. The method of claim 8, wherein a downlink band associated with the first SBFD configuration is adjacent to a downlink band associated with the slot information.

10. The method of claim 8, wherein an uplink band associated with the second SBFD configuration is adjacent to an uplink band associated with the slot information.

11. A method, comprising:
receiving, by a processor of an apparatus, at least two sub-band full duplex (SBFD) configurations from a network node;
applying, by the processor, the at least two SBFD configurations, wherein the at least two SBFD configurations comprises a first SBFD configuration and a second SBFD configuration;
transceiving, by the processor, data with the network node within a first set of slots according to the first SBFD configuration; and
transceiving, by the processor, data with the network node within a second set of slots according to the second SBFD configuration.

12. The method of claim 11, wherein the at least two SBFD configurations are included in a higher layer signaling.

13. The method of claim 11, wherein the at least two SBFD configurations are included a layer-1 signaling.

14. The method of claim 11, further comprising:
receiving, by the processor, an indicator from the network node, wherein the indicator indicates that the first SBFD configuration is applied to the first set of slots and the second SBFD configuration is applied to the second set of slots.

15. The method of claim 14, wherein the second set of slots does not overlap the first set of slots.

16. The method of claim 14, wherein the indicator is included in a higher layer signaling.

17. The method of claim 14, wherein the indicator is included in a layer-1 signaling.

18. The method of claim 11, wherein a downlink band associated with the first SBFD configuration is adjacent to a downlink band associated with a slot information of another network node.

19. The method of claim 11, wherein an uplink band associated with the second SBFD configuration is adjacent to an uplink band associated with a slot information of another network node.

20. An apparatus, comprising:
a transceiver which, during operation, wirelessly communicates with a network node; and
a processor communicatively coupled to the transceiver such that, during operation, the processor performs operations comprising:
receiving, via the transceiver, at least two sub-band full duplex (SBFD) configurations from the network node;
applying the at least two SBFD configurations, wherein the at least two SBFD configurations comprises a first SBFD configuration and a second SBFD configuration;
transceiving, via the transceiver, data with the network node within a first set of slots according to the first SBFD configuration; and
transceiving, via the transceiver, data with the network node within a second set of slots according to the second SBFD configuration.
